(19) United States
(12) Patent Application Publication
(10) Pub. No.: US 2007/0290471 A1
(43) Pub. Date: Dec. 20, 2007

(54) Expandable receptacle

(76) Inventor: David Sexton, Lawton, OK (US)

Correspondence Address: DUNLAP CODDING & ROGERS, P.C., PO BOX 16370, OKLAHOMA CITY, OK, 73113, US

(21) Appl. No.: 11/454,392

(22) Filed: Jun. 15, 2006

(51) Int. Cl. B62B 5/00

(52) U.S. Cl. 280/79.5

(57) ABSTRACT

An expandable receptacle comprising an outer tubular member and an inner tubular member. The inner tubular member is concentrically positioned in, and supported by, the outer tubular member in a telescoping relationship such that one of the inner tubular member and the outer tubular member is moveable along a longitudinal axis of the inner tubular member and the outer tubular member between a collapsed position and an expanded position. The inner tubular member and the outer tubular member cooperate to define a content receiving compartment having an open top and an open bottom whereby contents of the content receiving compartment are removable therefrom by lifting the inner tubular member and the outer tubular member upward and away from the contents.

### BACKGROUND OF THE INVENTION

1. Field of the Invention

The present invention relates generally to a container, and more particularly, but not by way of limitation, to an improved expandable receptacle that allows quick and easy removable of the contents of the receptacle.

2. Brief Description of Related Art

Convention trash receptacles are configured with a specific capacity. A common practice is to line the trash receptacle with a plastic liner to facilitate disposal of the refuse collected in the receptacle. In many instances, it is desirable to use large capacity liners, e.g., 55 to 60 gallons. Such large capacity liners have the advantage of being more cost effective than smaller capacity liners and do not require changing as often. However, problems are encountered with the use of large capacity liners. First, individuals are more susceptible to injury when pulling the liner from the receptacle due to the increased weight of the larger liner. Second, the receptacle used to support a large capacity liner must be of sufficient size to do so. Consequently, it may be inconvenient to store a receptacle of such size.

To this end, a need exists for an improved expandable receptacle that allows quick and easy removal of the contents of the receptacle. It is to such an apparatus that the present invention is directed.

### BRIEF DESCRIPTION OF THE SEVERAL VIEWS OF THE DRAWINGS

FIG. 1 is a cross sectional, exploded view of an expandable receptacle.

FIG. 2 is a cross sectional view of the expandable receptacle shown in a collapsed position.

FIG. 3 is a cross sectional view of the expandable receptacle shown in an expanded position.

FIG. 4 is an elevational view of the expanded receptacle with the inner and outer tubular members removed.

FIG. 5 is a cross sectional, exploded view of another embodiment of an expandable receptacle.

FIG. 6 is a cross sectional view of the expandable receptacle of FIG. 5 shown in a collapsed position.

FIG. 7 is an enlarged fragmentary view of a stop mechanism.

FIG. 8 is an enlarged fragmentary view of an interlocking mechanism.

### DETAILED DESCRIPTION OF THE INVENTION

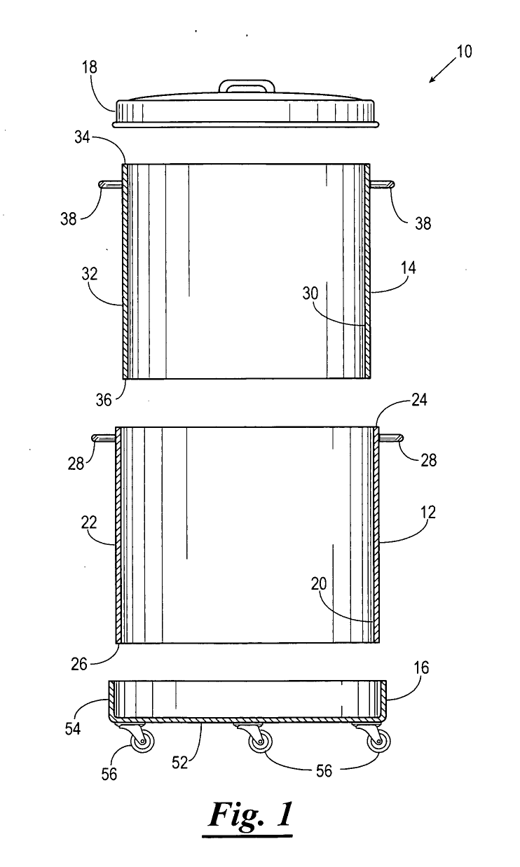

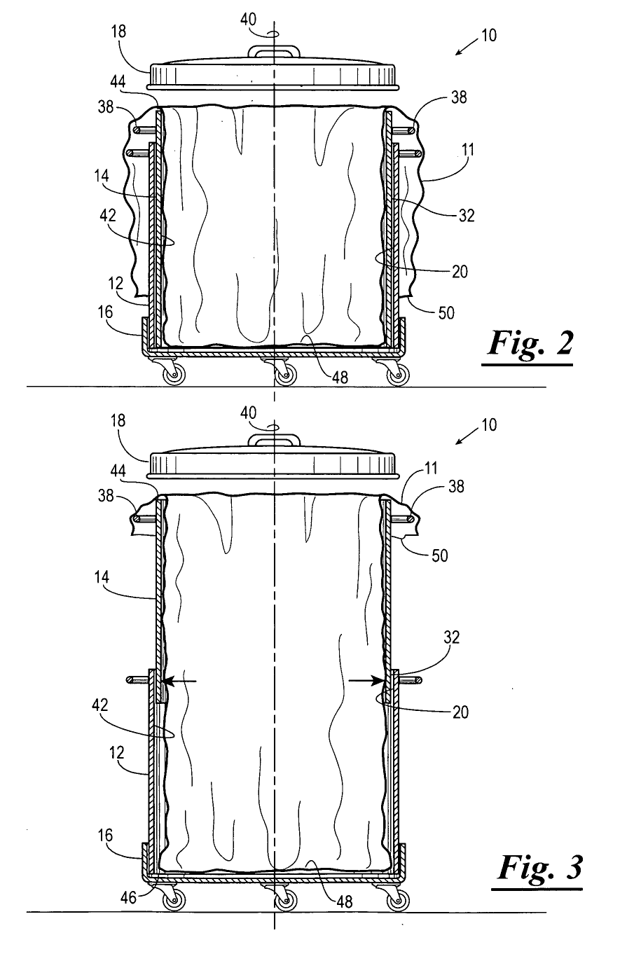

Referring now to the drawings, and more particularly to FIGS. 1-3, an expandable receptacle 10 constructed in accordance with the present invention is shown. The expanded receptacle 10 is illustrated as functioning as a support for a plastic liner 11 (FIGS. 2 and 3). However, it should be appreciated that the use of the expandable receptacle 10 of the present invention is not limited to being used as a liner support. The expandable receptacle 10 may be used for storing or transporting a variety of objects.

The expandable receptacle 10 has an outer tubular member 12, an inner tubular member 14, a stand 16, and a lid 18. The outer tubular member 12 has inner surface 20, an outer surface 22, an open top 24, and an open bottom 26. A pair of handles 28 are provided on the outer surface to facilitate moving the outer tubular member 12. Similarly, the inner tubular member 14 has an inner surface 30, an outer surface 32, an open top 34, and open bottom 36. The outer surface 32 of the inner tubular member 14 may also be provided with a pair of handles 38.

The inner tubular member 14 is dimensioned to fit in the outer tubular member 12 in a telescopic relationship with the outer surface 32 of the inner tubular member 14 contacting the inner surface 20 of the outer tubular member 12. The outer tubular member 12 and the inner tubular member 14 are preferably manufactured from a durable, plastic material, such as polyethylene, so as to permit the inner tubular member 14 to slide relative to the outer tubular member 12 and thereby permit the inner tubular member 14 to be moved along a longitudinal axis 40 of the inner tubular member 14 and the outer tubular member 12 from a collapsed position (FIG. 2) to an expanded position (FIG. 3). Furthermore, the inner tubular member 14 is constructed to have sufficient flexibility so that a pressure exerted on the inner surface 30 of the inner tubular member 14 causes the outer surface 32 of the inner tubular member 14 to frictionally engage the inner surface 20 of the outer tubular member 12 to support the inner tubular member 14 in the expanded position, in a manner to be described below.

The outer tubular member 12 and the inner tubular member 14 are shown to have a circular shape. However, it should be appreciated that the outer tubular member 12 and the inner tubular member 14 may be constructed of various and geometric shapes. In addition, the outer tubular member 12 and the inner tubular member 14 may be made from various materials, such as metal, plastic, and wood.

The outer tubular member 12 and the inner tubular member 14 cooperate to define a content receiving compartment 42 having an open top 44 and an open bottom 46, whereby contents of the content receiving compartment 42 are removable therefrom by lifting the inner tubular member 14 and the outer tubular member 12 upward and away from the contents. As mentioned above, the expandable receptacle 10 is illustrated in FIGS. 2 and 3 as functioning as a support for the liner 11, which has a closed lower end 48 and an open upper end 50. The liner 11 is positioned in the content receiving compartment 42 with the open upper end 50 extended over the top 34 of the inner tubular member 14. While the capacity of the liner 11 may vary, the expandable receptacle 10 effectively supports large capacity liners, such as those liners having a capacity of approximately 60 gallons, by way of example.

The stand 16 is adapted to support the liner 11, the outer tubular member 12, and the inner tubular member 14. The stand 16 includes a base 52 and a sidewall 54 dimensioned to receive and support the bottom 26 of the outer tubular member 12. The stand 16 and the outer tubular member 12 may be provided with a latching mechanism (not shown) that releaseably connects the outer tubular member 12 to the stand 16. Such latching mechanism may include a foot pedal (also not shown) to facilitate release of the outer tubular member 12 from the stand 16 when it is desired to remove the contents of the content receiving compartment 42 therefrom. The stand 16 preferably includes a plurality of wheels or rollers 56 to permit the expandable receptacle 10 and its contents to be moved from one location to another, as desired.

In use, refuse or other materials are disposed in the liner 11 with the inner tubular member 14 and the outer tubular member 12 in the collapsed position (FIG. 2). As the content receiving compartment 42 becomes filled, the inner tubular member 14 is moved upward to increase the capacity of the content receiving compartment 42 by lifting the inner tubular member 14 with the handles 38 to a desired position. The inner tubular member 14 is supported in the expanded position (FIG. 3) by the outward pressure exerted on the inner tubular member 14 by the contents of the liner 11. More specifically, the contents of the content receiving compartment 42 cause the outer surface 32 of the inner tubular member 14 to frictionally engage the inner surface 20 of the outer tubular member 12 and thereby support the inner tubular member 14 in the expanded position. The inner tubular member 14 is moved upward incrementally until the capacity of the liner 11 is reached. Prior to the liner 11 being filled to capacity, the lid 18 may be used to cover the liner 11.

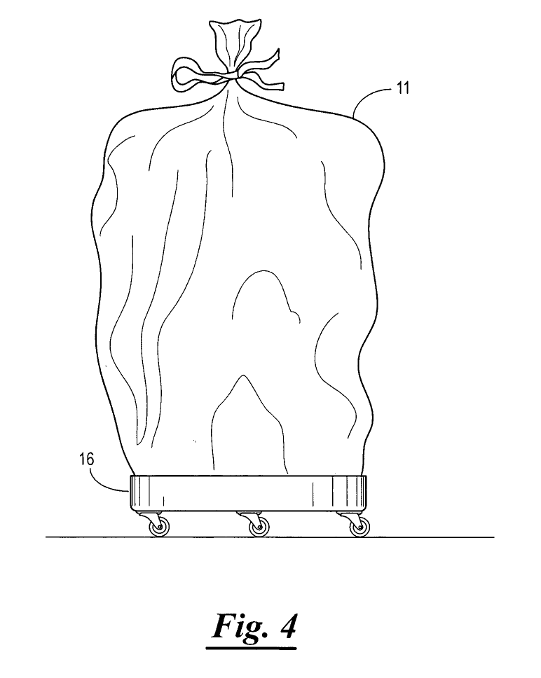

With the liner 11 filled to its capacity, the liner 11 is tied or otherwise sealed. The filled liner 11 is removed from the expandable receptacle 10 (FIG. 4) by lifting the inner tubular member 14 and the outer tubular member 12 upward and away from the liner 11. If the outer tubular member 12 is connected to the stand 16, the outer tubular member 12 is first disconnected from the stand 16. Next, the inner tubular member 14 is lifted up and over the liner 11, followed by the outer tubular member 12. Alternatively, the outer tubular member 12 may be lifted so as to cause the top 24 of the outer tubular member 12 to contact the handles 38 of the inner tubular member 14 whereby the outer tubular member 12 and the inner tubular member 14 are lifted over the liner 11 as a unit. With the outer tubular member 12 and the inner tubular member 14 separated from the liner 11, the filled liner 11 may be transported via the stand 16 to a desired location for disposal, without requiring the liner 11 being lifted out of the expandable receptacle 10.

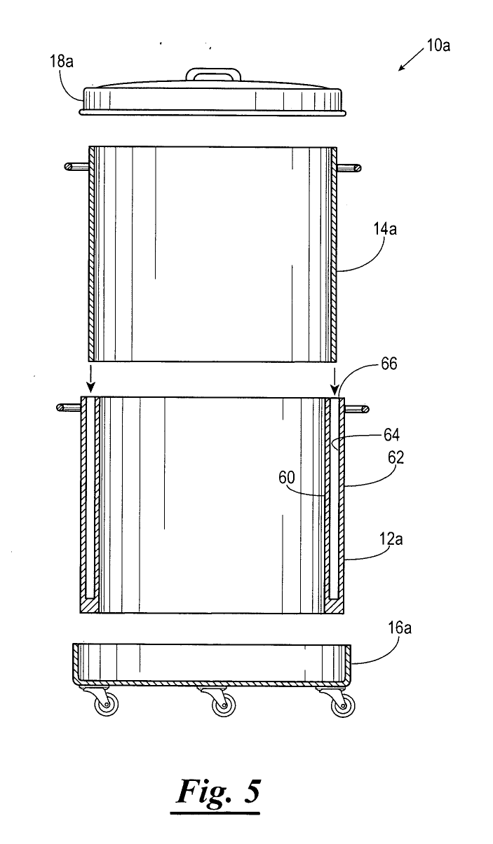

Referring now to FIGS. 5 and 6, another embodiment of an expandable receptacle 10a is illustrated. The expandable receptacle 10a has an outer tubular member 12a, an inner tubular member 14a, a stand 16a, and a lid 18a. The inner tubular member 14a, the stand 16a, and the lid 18a are similar in construction to the inner tubular member 14, the stand 16, and the lid 18 described above. The outer tubular member 12a has an inner wall 60 and a outer wall 62 joined at a lower end thereof. The inner wall 60 and the outer wall 62 are spaced to define a slot 64 having an open top 66. The slot 64 is dimensioned to receive the inner tubular member 14a so that the inner tubular member 14a is movable from a collapsed position (FIG. 5) to an expanded position. The inner tubular member 14a is supported in the expanded position in a manner similar to that described above in reference to the expandable receptacle 10. That is, the contents of the content receiving compartment exerts a pressure on the inner wall 60 of the outer tubular member 12a, which in turn squeezes the inner tubular member 14a between the inner wall 60 and the outer wall 62.

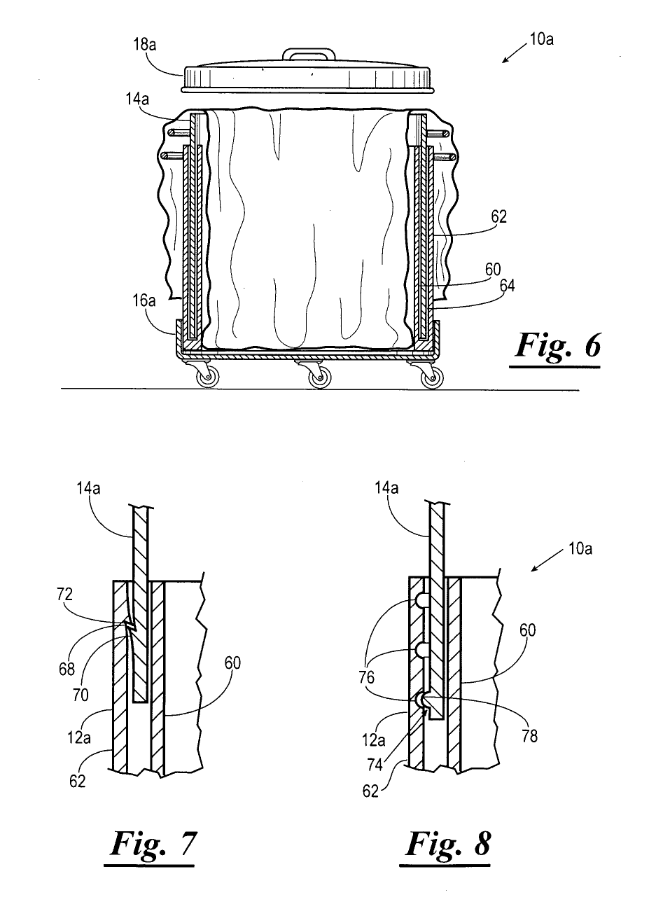

FIG. 7 shows the outer tubular member 12a and the inner tubular member 14a provided with a stop mechanism 68 which functions to prevent the inner tubular member 14a from separating from the outer tubular member 12a. The stop mechanism 68 includes a catch member 70 formed on the inner tubular member 14a near the bottom thereof and a catch member 72 formed on the outer tubular member 12a near the top thereof. It should be appreciated that the stop mechanism 68 may also be employed in the expandable receptacle 10.

FIG. 8 illustrates the expandable receptacle 10a provided with an interlocking mechanism 74 as an additional or alternative means for supporting the inner tubular member 14a in the expanded position. The outer tubular member 12a may include a series of recesses 76 adapted to receive a ridge 78 formed on the inner tubular member 14a. It will be appreciated that the interlocking mechanism 74 may take a variety of other forms. For example, the ridge 78 may be formed on the outer tubular member 12a (the outer wall, the inner wall, or both) and the recesses 76 formed on the inner tubular member 14a so as to correspond with the ridge of the outer tubular member 12a. The interlocking mechanism 74 may be incorporated into the expandable receptacle 10.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. An expandable receptacle, comprising:
an outer tubular member having an outer surface, an inner surface, an open top, and an open bottom; and
an inner tubular member having an outer surface, an inner surface, an open top, and an open bottom, the inner tubular member concentrically positioned in, and supported by, the outer tubular member in a telescoping relationship such that one of the inner tubular member and the outer tubular member is moveable along a longitudinal axis of the inner tubular member and the outer tubular member between a collapsed position and an expanded position, the inner tubular member and the outer tubular member cooperating to define a content receiving compartment having an open top and an open bottom whereby contents of the content receiving compartment are removable therefrom by lifting the inner tubular member and the outer tubular member upward and away from the contents.

2. The expandable receptacle of claim 1 further comprising a stand supporting the inner and the outer tubular members.

3. The expandable receptacle of claim 2, wherein the stand has a plurality of wheels.

4. The expandable receptacle of claim 1 further comprising a liner having a closed lower end and an open upper end, the liner positioned in the content receiving compartment and extended over the top of the inner tubular member.

5. The expandable receptacle of claim 1, wherein the inner tubular member has at least one handle extending from the outer surface thereof.

6. The expandable receptacle of claim 1, wherein the outer tubular member has at least one handle extending from the outer surface thereof.

7. The expandable receptacle of claim 1, wherein the outer surface of the inner tubular member is positioned adjacent the inner surface of the outer member such that contents disposed in the content receiving compartment cause the outer surface of the inner surface to frictionally engage the inner surface of the outer tubular member and thereby support the inner tubular member in the expanded position.

8. The expandable receptacle of claim 1 further comprising:
means for interlocking the inner tubular member and the outer tubular member to support the inner tubular member in the expanded position.

9. The expandable receptacle of claim 1, further comprising:
means for engaging a portion of the inner tubular member with the outer tubular member to prevent the inner tubular member from detaching from the outer tubular member.

10. The expandable receptacle of claim 1, wherein the outer tubular member has an outer wall and an inner wall spaced apart from one another to define a slot having an open top, and wherein the inner tubular member is positioned in the slot of the outer tubular member.

11. An expandable receptacle, comprising:
an outer tubular member having an outer surface, an inner surface, and an open top; and
an inner tubular member having an outer surface, an inner surface, and an open top, the inner tubular member concentrically positioned in, and supported by, the outer tubular member in a telescoping relationship such that one of the inner tubular member and the outer tubular member is moveable along a longitude axis of the inner tubular member and the outer tubular member between a collapsed position and an expanded position, the inner tubular member and the outer tubular member cooperating to define a content receiving compartment having an open top, the outer surface of the inner tubular member positioned adjacent the inner surface of the outer member such that contents disposed in the content receiving compartment cause the outer surface of the inner surface to frictionally engage the inner surface of the outer tubular member and thereby support the inner tubular member in the extended position.

12. The expandable receptacle of claim 11 further comprising a stand supporting the inner and the outer tubular members.

13. The expandable receptacle of claim 11, wherein the stand has a plurality of wheels.

14. The expandable receptacle of claim 11 further comprising a liner having a closed lower end and an open upper end, the liner positioned in the content receiving compartment and extended over the top of the inner tubular member.

15. The expandable receptacle of claim 11, wherein the inner tubular member has at least one handle extending from the outer surface thereof.

16. The expandable receptacle of claim 11, wherein the outer tubular member has at least one handle extending from the outer surface thereof.

17. The expandable receptacle of claim 11 further comprising:
means for interlocking the inner tubular member and the outer tubular member to support the inner tubular member in the expanded position.

18. The expandable receptacle of claim 11 further comprising:
means for engaging a portion of the inner tubular member with the outer tubular member to prevent the inner tubular member from detaching from the outer tubular member.

19. The expandable receptacle of claim 11, wherein the outer tubular member has an outer wall and an inner wall spaced apart from one another to define a slot having an open top, and wherein the inner tubular member is positioned in the slot of the outer tubular member.
